(19) United States
(12) Patent Application Publication
(10) Pub. No.: US 2019/0171898 A1
(43) Pub. Date: Jun. 6, 2019

(54) INFORMATION PROCESSING APPARATUS AND METHOD

(71) Applicant: CANON KABUSHIKI KAISHA, Tokyo (JP)

(72) Inventor: Satoshi Igeta, Kawasaki-shi (JP)

(21) Appl. No.: 16/206,593

(22) Filed: Nov. 30, 2018

(30) Foreign Application Priority Data
Dec. 4, 2017 (JP) 2017-232334

(51) Int. Cl. G06K 9/32; G06K 9/00; G06T 3/40; G06F 16/583

(52) U.S. Cl. CPC G06K 9/3241; G06F 16/583; G06T 3/4092; G06K 9/00201

(57) ABSTRACT

An apparatus and method acquire a region of an object contained in an image captured by an image capturing unit for each object and store object management data in a memory. An image is generated for inquiry from an image of the region of the object in an object management table for which no image analysis result is received, and an inquiry is transmitted to an image analysis server via a communication unit. An inquiry result is received from the image analysis server and stored in the object management table in association with the corresponding object.

### BACKGROUND

### Field

The present disclosure relates to an information processing apparatus and method for transmitting an inquiry about an object contained in image data to an image analysis server.

### Description of the Related Art

Mobile terminals have been used to transmit image data to servers via networks.

Japanese Patent Application Laid-Open No. 2003-323620 discusses a technique in which a server extracts and identifies an object from an image captured by a camera of a mobile terminal, searches a database based on the identification result, and transmits the search result to the mobile terminal.

In order to increase the accuracy of object extraction and identification by a server, the server needs to perform a large number of optimum image analyses to learn images, accumulate the learning results, and make inferences.

If the server receives a large number of images for learning, the communication amount increases.

### SUMMARY

The present disclosure is directed to a technique for reducing the amount of image data received by a server while improving the accuracy of object recognition by the server.

According to an aspect of the present disclosure, an information processing apparatus includes a processor, and a memory storing a program which, when executed by the processor, causes the information processing apparatus to input image data, detect an object included in the image data, acquire a region of the detected object in the image data, store the acquired region for each object in an object management table, erase, from the object management table, an object that is stored in the object management table and is not included in new input image data, transmit, to an image analysis apparatus, an object image cut from the image data based on a region of the object that is stored in the object management table and with which no associated analysis result is stored, receive a result of analysis of the object image from the image analysis apparatus, and store the result of analysis of the object image in the object management table in association with a corresponding object.

Further features will become apparent from the following description of exemplary embodiments with reference to the attached drawings.

### BRIEF DESCRIPTION OF THE DRAWINGS

FIG. 1 illustrates an example of a system configuration in an exemplary embodiment.

FIG. 2 is a block diagram schematically illustrating a configuration in an exemplary embodiment.

FIG. 3 illustrates an example of a screen in an exemplary embodiment.

FIG. 4 illustrates an example of a configuration of an object management table in an exemplary embodiment.

FIG. 5A is an operation flowchart in an exemplary embodiment.

FIG. 5B is an operation flowchart following the operation flowchart in FIG. 5A in an exemplary embodiment.

### DESCRIPTION OF THE EMBODIMENTS

An exemplary embodiment of the present disclosure will be described in detail below with reference to the drawings.

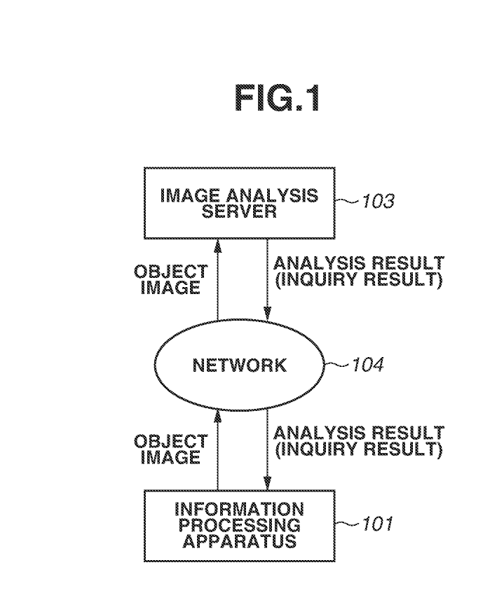

The following describes a first exemplary embodiment. FIG. 1 is a block diagram schematically illustrating a configuration of an image analysis system according to the present exemplary embodiment. An information processing apparatus 101 communicates with an image analysis server 103 via a network 104 based on standard protocols. The information processing apparatus 101 includes an image capturing unit configured to output a moving image, an object recognition unit configured to recognize and an object and an identity of the object from each piece of image data of a moving image output from the image capturing unit, and a separation unit configured to separate an image portion including an object from the captured image data. The information processing apparatus 101 also includes a recording/reproduction unit configured to record and reproduce moving and still images based on a moving image output from the image capturing unit, and a display unit configured to display a moving image output from the image capturing unit and moving and still images output from the recording/reproduction unit.

The information processing apparatus 101 transmits an image (object image) indicating an object contained in a captured image or an image for inquiry together with object identification information about each object and captured image identification information (e.g., frame number) to the image analysis server 103. The image analysis server 103 analyzes the object image transmitted from the information processing apparatus 101 and transmits the analysis result in a description language format, such as Hypertext Markup Language (HTML) or Extensible Markup Language (XML) format, together with the object identification information and the image identification information to the information processing apparatus 101. In the image analysis, the type of the object, such as person, car, dog, mountain, or building, is determined and, if possible, the name of the object is identified.

The information processing apparatus 101 tags the corresponding frame of the corresponding moving image with the type/name of the subject based on the analysis result transmitted from the image analysis server 103 and, as needed, displays the tag on the display unit. The information processing apparatus 101 uses the analysis result of the image analysis server 103 in selecting an image capturing mode or processing a captured image.

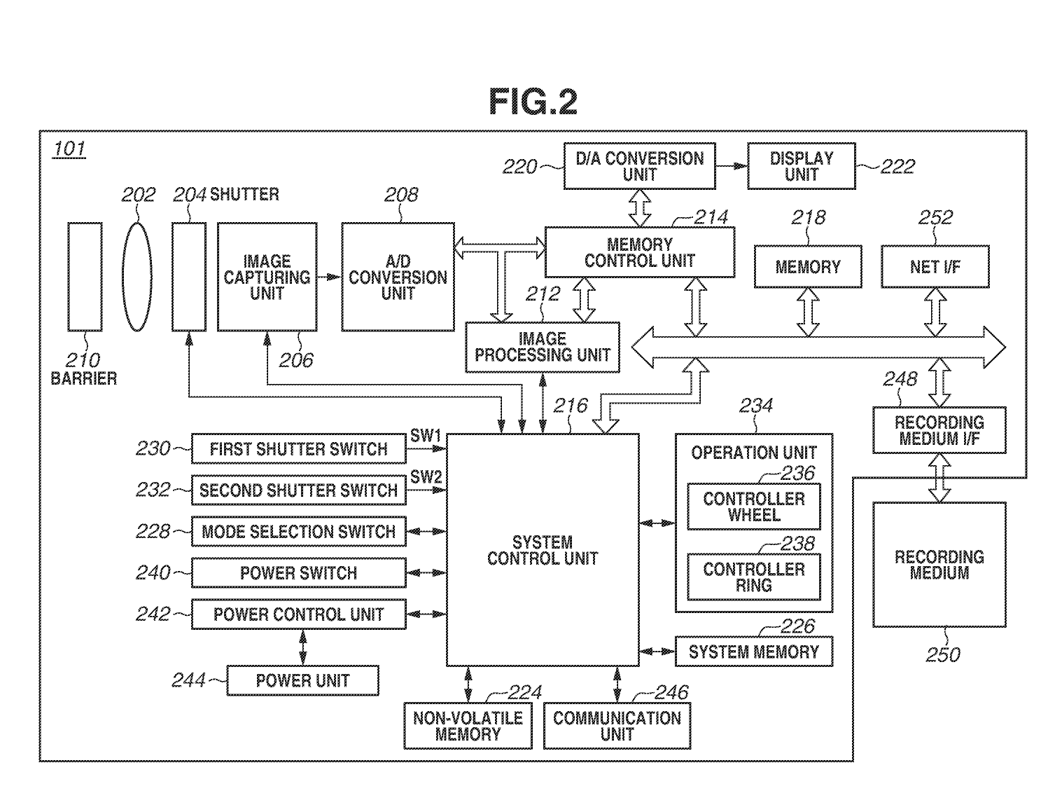

FIG. 2 is a block diagram schematically illustrating a configuration of an image capturing apparatus used as the information processing apparatus 101. An image capturing lens 202 includes a zoom lens and a focus lens. A shutter 204 includes a diaphragm function. An image capturing unit 206 includes a charge-coupled device (CCD) or complementary metal oxide semiconductor (CMOS) image sensor configured to convert an optical image into an electric signal. An analog/digital (A/D) conversion unit 208 converts an analog signal output from the image capturing unit 206 into a digital signal. A barrier 210 covers the image capturing unit including the image capturing lens 202 to protect an image capturing system including the image capturing lens 202, the shutter 204, and the image capturing unit 206 from contamination and breakage.

An image processing unit 212 performs predetermined resizing processing and color conversion processing, such as pixel interpolation and reduction, on image data from the A/D conversion unit 208 or image data from a memory control unit 214. The image processing unit 212 performs predetermined computation processing on the captured image data, and a system control unit 216 performs exposure control and ranging control based on the obtained computation result.

The output data from the AD conversion unit 208 is written directly to a memory 218 via the image processing unit 212 and the memory control unit 214 or via the memory control unit 214. The memory 218 stores the image data acquired by the image capturing unit 206 and converted into digital data by the A/D conversion unit 208 and the image data to be displayed on a display unit 222. The memory 218 has sufficient storage capacity to store a predetermined number of still images and a predetermined time of moving images and audio.

The memory 218 is also used as a memory (video memory) for image display. A digital/analog (D/A) conversion unit 220 converts image data for display stored in the memory 218 into an analog signal and supplies the analog signal to the display unit 222. In this way, the display unit 222 displays an image specified by the image data for display written to the memory 218.

A non-volatile memory 224 is an electrically erasable/recordable memory and, for example, an electrically erasable programmable read-only memory (EEPROM) is used. The non-volatile memory 224 stores a constant number, a program, etc. for the operations of the system control unit 216. As used here, the program refers to a program for causing the system control unit 216 to realize the operations described below.

The system control unit 216 controls the entire image capturing apparatus. The system control unit 216 executes a control program recorded in the non-volatile memory 224 to realize the processing described below. A system memory 226 includes a random access memory (RAM). The constant and variable numbers for the operations of the system control unit 216, the program read from the non-volatile memory 224, etc. are loaded into the system memory 226.

A mode selection switch 228 transmits, to the system control unit 216, an instruction to change an operation mode of the image capturing apparatus to either a still image recording mode, a moving image recording mode, or a reproduction mode. A first shutter switch 230 is turned on if a shutter button is operated to a point between a start point and an end point, i.e., if the shutter button is half-pressed (image capturing preparation instruction), to generate a first shutter switch signal SW1. In response to the first shutter switch signal SW1, the system control unit 216 starts pre-processing (auto focusing, exposure determination, etc.) of image capturing. A second shutter switch 232 is turned on if the shutter button is completely operated, i.e., if the shutter button is full-pressed (image capturing instruction), to generate a second shutter switch signal SW2. In response to the second shutter switch signal SW2, the system control unit 216 starts a series of operations of image capturing processing from the signal reading from the image capturing unit 206 to the image data waiting to a recording medium 250.

An operation unit 234 includes a touch panel placed on a screen of the display unit 222 and can input, to the system control unit 216, an operation instruction assigned to a function icon by an operation of selecting a function icon displayed on the display unit 222. Examples of the function button include a check button, end button, return button, image forward button, jump button, narrow-down button, and attribute change button. For example, if a menu button is pressed, a menu screen for various settings is displayed on the display unit 222. A user can make various settings using the menu screen displayed on the display unit 222 and the function buttons on the screen or a four-direction button (cross-key) of upward, downward, rightward, and leftward directions and a “SET” button.

A controller wheel 236 is an operation member that is included in the operation unit 234 and can rotate. The controller wheel 236 is used together with the direction button to specify a selected item, etc. If the controller wheel 236 is rotated, an electric pulse signal is generated based on the operation amount, and the system control unit 216 controls the components of the image capturing apparatus based on the pulse signal. With the pulse signal, the system control unit 216 can determine the angle, rotation amount, etc. of the rotation operation performed on the controller wheel 236.

The controller wheel 236 can be any operation member that detects a rotation operation. For example, the controller wheel 236 can be a dial operation member in which the controller wheel 236 is rotated by a user rotation operation to generate a pulse signal. The controller wheel 236 can be an operation member that includes a touch sensor and detects a rotation operation of the finger of the user, etc. on the controller wheel 236 and the controller wheel 236 is not rotated. This is a so-called touch wheel.

A controller ring 238 is a rotation operation member included in the operation unit 234 and is rotatable about an optical axis around a lens barrel. For example, if the controller ring 238 is operated, the controller ring 238 generates a number of electric pulse signals corresponding to the rotation amount (operation amount) and supplies the electric pulse signals to the system control unit 216. The system control unit 216 controls the components of the image capturing apparatus based on the pulse signals from the controller ring 238. The controller ring 238 includes a function selection button, and if the function selection button is pressed by the user, the system control unit 216 displays, on the display unit 222, a menu screen via which the function to be assigned to the controller ring 238 is changeable.

The controller wheel 236 and the controller ring 238 are used to select a normal mode item and change a value.

The power of the image capturing apparatus can be turned on/off using a power switch 240.

A power control unit 242 includes a battery detection circuit, a direct-current (DC)-DC converter, and a switch circuit for changing a block to pass electricity and detects the presence/absence of an attached battery, battery type, and remaining battery amount. The power control unit 242 controls the DC-DC converter based on the detection result and an instruction from the system control unit 216 and supplies a required voltage for a required period to the components including the recording medium 250.

A power unit 244 includes a primary battery, such as an alkali battery or lithium battery, and a secondary battery, such as a nickel-cadmium (NiCd) battery, nickel-metal hydride (NiMH) battery, or lithium-ion (Li) battery, or alternating-current (AC) adapter.

A communication unit 246 communicates with another apparatus wirelessly or via a cable to transmit and receive various types of data including image data and a control signal.

A recording medium interface (I/F) 248 is connected with the recording medium 250 such as a memory card or hard disk.

A network I/F 252 communicates with another apparatus (the image analysis server 103 in the present exemplary embodiment) via a network under control of the system control unit 216.

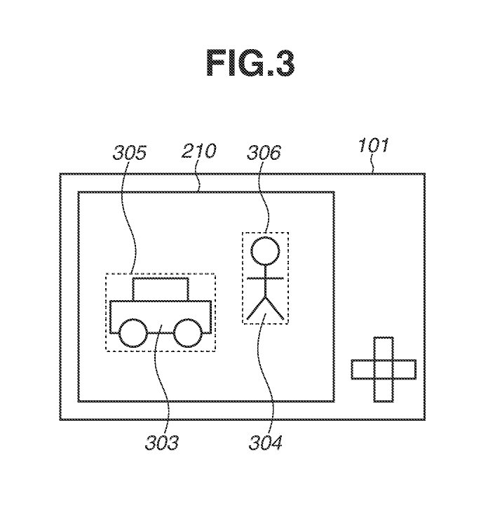

FIG. 3 illustrates an example of the screen of the display unit 222. An object 303 indicates a “car” as an object example. An object 304 indicates a “person” as an object example. A region 305 is a region cut as an object image of the object 303. A region 306 is a region cut as an object image of the object 304. While the regions 305 and 306 cut as object images are illustrated in FIG. 3 for the convenience of description, the regions 305 and 306 do not have to be displayed on the display unit 222.

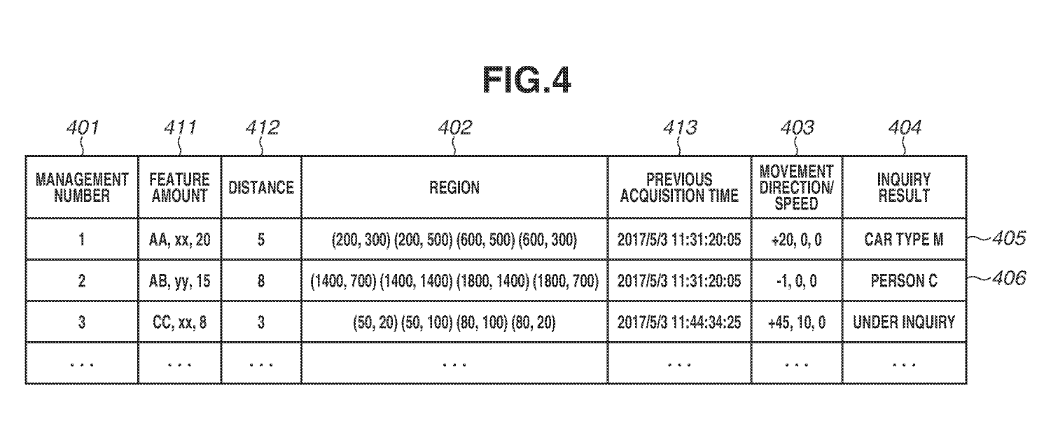

The system control unit 216 stores and manages information about an object recognized from a captured image in an object management table of the system memory 226. FIG. 4 illustrates an example of a data configuration of the object management table. A management number 401 indicates the management number (object management number) of a region cut as an object image. A region 402 indicates a region obtained by cutting the object image. A movement direction/speed 403 indicates the vectorial movement direction/speed per unit time with the object being the center. An inquiry result 404 indicates an inquiry result returned from the image analysis server 103.

A feature amount 411 indicates the feature amount of the object. A distance 412 indicates the distance to the object. A previous acquisition time 413 indicates the previous acquisition time of the object.

A record/entry 405 indicates a record or entry to store information about the object 303. The object 303 is moved rightward by 20 pixels per unit time. The image analysis server 103 determines the object 303 as “car”. A record/entry 406 indicates a record or entry to store information about the object 304. The object 304 is moved leftward by 1 pixel per unit time. The image analysis server 103 determines the object 304 as “person”.

While the object of management number 1 is simply moved rightward and the object of management number 2 is simply moved leftward for the convenience of description, the movement direction can be any direction in three dimensions. While the movement per unit time is specified in pixel, the actual distance of the object can be used.

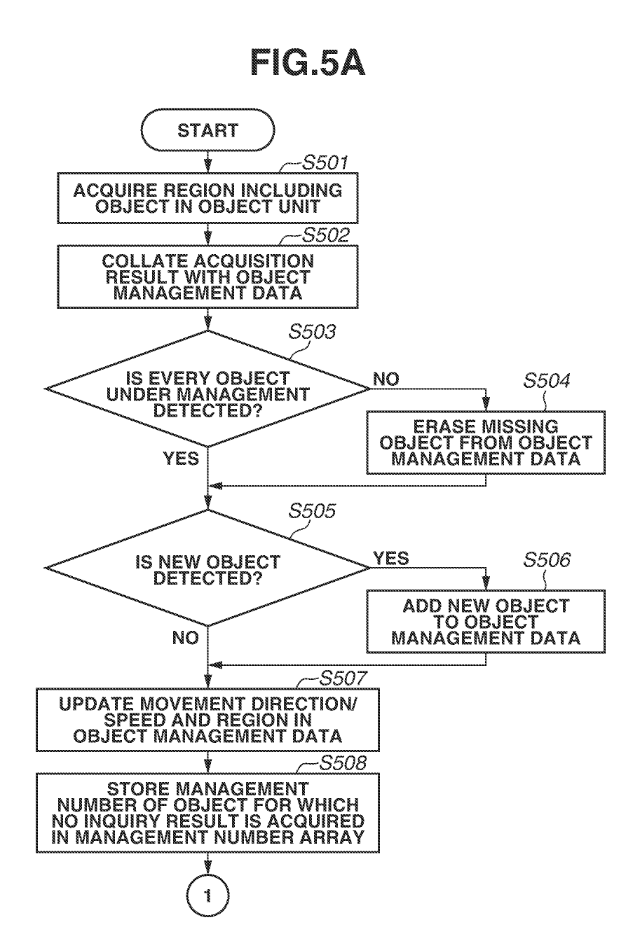

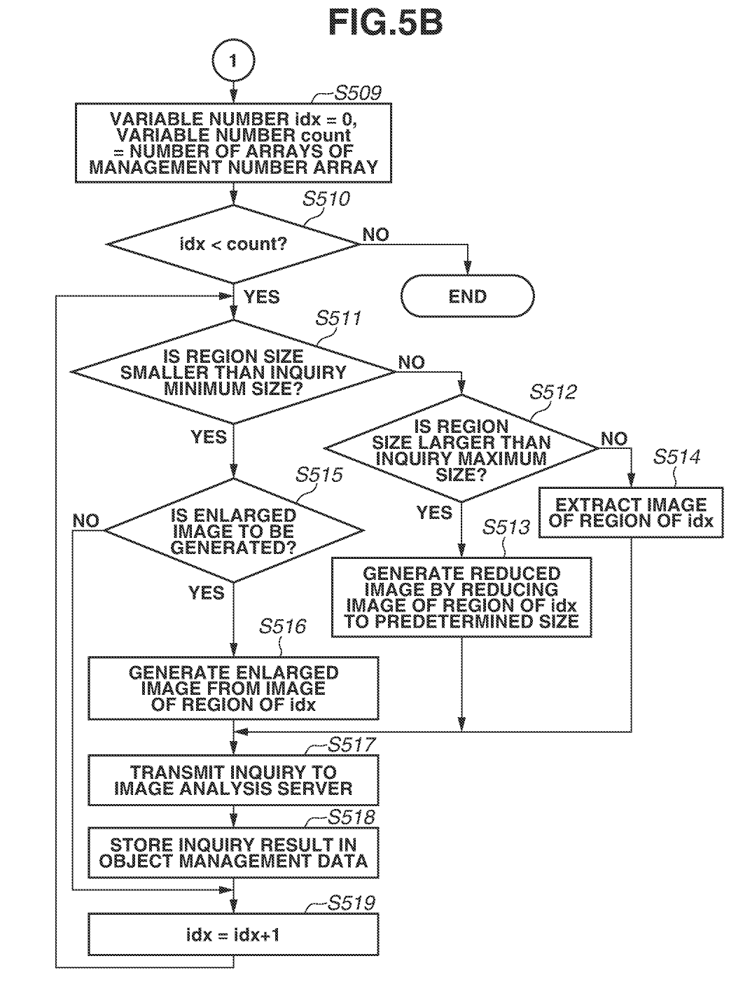

FIGS. 5A and 5B are flowcharts illustrating the operations of the information processing apparatus 101. When image data of a captured image is input from the A/D conversion unit 208 to the image processing unit 212, the system control unit 216 starts the process in FIGS. 5A and 5B. While the timing at which the image processing unit 212 retrieves image data (captured image) from the A/D conversion unit 208 is described as the timing at which the process in FIGS. 5A and 5B is executed for the convenience of description, the process in FIGS. 5A and 5B can be executed at predetermined time unit. In the present exemplary embodiment, the image data input to the image processing unit 212 is a live-view image being captured by the image capturing apparatus or a frame image of a moving image recorded in a medium.

In step S501, the system control unit 216 analyzes the input image data to detect an object and acquires (a region of) an object image in object unit. In object recognition and separation, a publicly-known subject/object recognition technique for face recognition or object recognition can be used. In step S501, the system control unit 216 also acquires the distance from the image capturing unit 206 to the detected object. Then, the system control unit 216 stores in the memory 218 the feature amount (e.g., color, shape, size) and distance of the acquired object image and the coordinates specifying the location of the object image in the image data. In the present exemplary embodiment, the coordinates are specified by x- and y-coordinates with the lower left of the image data being the origin. In step S501, if a plurality of objects is detected in the image data, a plurality of object images is acquired.

In step S502, the system control unit 216 collates the feature amount and distance of each object acquired in step S501 with information about each object stored in the object management table in FIG. 4. Specifically, the system control unit 216 determines whether the same object is present in the object management table based on the feature amount 411 and the distance 412 of each object, the region 402 indicating the coordinates of the location of the object image in the image data, the previous acquisition time 413 of the object image, and the movement direction/speed 403 of the object, which will be described below, stored in the object management table. More specifically, the system control unit 216 first searches the object management table for a feature amount that is similar to the feature amount of the object image acquired in step S501. At this time, the system control unit 216 determines whether the color and/or shape as a feature amount is similar. In this way, for example, a red sports-car type car is identified as the same object. The system control unit 216 determines the similarity by comparing the combination of “the size of the object image and the distance from the object to the image capturing unit 206”. In this way, an object that is located at a short distance and has a large size is determined to be similar to an object that is located at a great distance and has a small size and, for example, in the case where a car is moving at a great distance from the information processing apparatus 101, the car is identified as the same object regardless of whether the car is imaged in a close region or far region. The system control unit 216 determines the similarity by comparing the combination of “the location of the object image in the image data and the movement direction described below”. In this way, even if the car is moved to change the position in the image data, the car is identified as the same object. The system control unit 216 calculates a range within which the previous object is movable, based on the movement speed described below and the time that passes from the acquisition time of the previous object image to the acquisition time of the current object image. If the coordinates of the current object image are within the calculated range, the object is determined to be similar, whereas if the coordinates are outside the range, the object is determined not to be similar. In this way, if another car similar in color and shape appears, the system control unit 216 can identify the other car as a different object.

In step S503, the system control unit 216 determines whether every object managed by the object management table is detected in step S501 as a result of the collation in step S502. If the system control unit 216 determines that every object managed by the object management table is detected (YES in step S503), the processing proceeds to step S505. If the system control unit 216 determines that even one object in the object management table is not detected, i.e., if one or more objects are not within the image capturing range (NO in step S503), the processing proceeds to step S504. In step S504, the system control unit 216 erases from the object management table the record of the object that is managed by the object management table but is not detected in step S501, and the processing proceeds to step S505. By the processing in step S504, for example, if a new car that is similar in color and shape appears next, the new car is managed as a different new object. Specifically, the new car that appears is likely a car different from the car managed in the object management table. However, if the record of the previous object remains in the object management table, the new car can be managed as the same object. In this case, no inquiry, which is described below, is transmitted to the image analysis server 103. Thus, in the present exemplary embodiment, if an object is not present in the image capturing range and disappears from the image data, the previous record corresponding to the missing object is erased. In this way, even if a new object that appears in the image data has a feature amount similar to a feature amount of a previous object, the new object is managed as a different object, so that an inquiry described below is transmitted to the image analysis server 103 to acquire a result. Thus, the accuracy of object recognition is improved.

In step S505, the system control unit 216 determines whether a new object that is not managed in the object management table is detected in step S501 as a result of the collation in step S502. If the system control unit 216 determines that a new object is detected in step S501 (YES in step S505), the processing proceeds to step S506. If the system control unit 216 determines that no new object is detected in step S501 (NO in step S505), the processing proceeds to step S507. In step S506, the system control unit 216 adds the record of the new recognized object to the object management table, and the processing proceeds to step S507.

By steps S503 to S506, the record of the object moved off the image capturing range is erased from the object management table, and the record of the new object moved into the image capturing range is added to the object management table. At this time, an inquiry about the analysis result is not yet transmitted to the image analysis server 103, so that the inquiry result 404 for the new object is blank.

In step S507, the system control unit 216 calculates the movement direction/speed 403 of the corresponding object in the object management table based on the region 402 and the distance at the time of the previous object image acquisition and the coordinates and distance at the time of the current object image acquisition that are stored in the memory 218 based on the result of collation in step S502. The movement direction in the present exemplary embodiment is specified as vector information with the object being the center and the vertically upward direction, horizontally rightward direction, and backward direction from the front of the image data are positive directions. Then, the system control unit 216 updates the region 402 of each object managed in the object management table with the coordinates at the time of object image acquisition and updates the movement direction/speed 403 with the calculated value.

In step S508, the system control unit 216 extracts the management number of the record with a blank analysis result in the object management table and stores the extracted management number in a management number array.

In step S509, the system control unit 216 sets a variable number idx to zero and a variable number count to the management number extracted in step S508.

In step S510, the system control unit 216 compares the variable number idx with the variable number count. If the variable number idx is greater than or equal to the variable number count (NO in step S510), the process illustrated in FIGS. 5A and 5B ends. If the variable number idx is less than the variable number count (YES in step S510), the processing proceeds to step S511.

By the processing in steps S511 to S516, the object image of the region 402 is enlarged/reduced.

In step S511, the system control unit 216 determines whether the size of the region 402 of the record of the management number in the object management table that is stored in the location specified by the variable number idx in the management number array is smaller than an inquiry minimum size with respect to the image analysis server 103. If the system control unit 216 determines that the size of the region 402 is larger than or equal to the inquiry minimum size (NO in step S511), the processing proceeds to step S512. If the system control unit 216 determines that the size of the region 402 is smaller than the inquiry minimum size (YES in step S511), the processing proceeds to step S515.

In step S512, the system control unit 216 determines whether the size of the region 402 of the record of the management number in the object management table that is stored in the location specified by the variable number idx in the management number array is larger than an inquiry maximum size with respect to the image analysis server 103. If the system control unit 216 determines that the size of the region 402 is larger than the inquiry maximum size (YES in step S512), the processing proceeds to step S513. If the system control unit 216 determines that the size of the region 402 is smaller than or equal to the inquiry maximum size (NO in step S512), the processing proceeds to step S514.

In step S513, the system control unit 216 generates an image for inquiry to the image analysis server 103 by reducing to a predetermined size the size of the image of the region 402 of the record of the management number in the object management table that is stored in the location specified by the variable number idx in the management number array. In this way, the communication amount needed for an inquiry to the image analysis server 103 can be reduced. The image size reduction processing can be omitted depending on the object.

In step S514, the system control unit 216 generates an image for inquiry by cutting, from the captured image, the image of the region 402 of the record of the management number in the object management table that is stored in the location specified by the variable number idx in the management number array.

In step S515, the system control unit 216 checks whether an enlarged image is to be generated for an inquiry to the image analysis server 103. For example, the user sets in advance whether to execute enlargement processing. If the system control unit 216 determines that the setting to generate an enlarged image is made (YES in step S515), the processing proceeds to step S516. If the system control unit 216 determines that the setting not to generate an enlarged image is made (NO in step S515), the processing proceeds to step S519. The enlargement processing is executed to enlarge an object that is too small in size to undergo image analysis, whereby image analysis becomes executable.

In the case where the enlargement processing is not executed, since the size does not satisfy the size range analyzable by the image analysis server 103, no inquiry is transmitted to the image analysis server 103. However, the object remains in the object management table as a record without an inquiry result. Thus, if the same object is detected in the next input captured image (step S501) and if the size of the object image is larger than the inquiry minimum size, an inquiry is transmitted to the image analysis server 103 and the object image becomes an image analysis target. Thus, needless transmission of an unanalyzable image to the image analysis server 103 can be avoided to reduce the communication load. Since an image that is adequate enough to be analyzed instead of an image that is not adequate enough is transmitted to the image analysis server 103, the accuracy of object recognition can be increased.

Alternatively, the processing in step S515 can be performed by the image analysis server 103 instead of the information processing apparatus 101. In this way, the size of the object image transmitted from the information processing apparatus 101 to the image analysis server 103 remains small, so that the communication load can be reduced.

In step S516, the system control unit 216 generates an image for inquiry by enlarging the image of the region 402 of the record of the management number in the object management table that is stored in the location specified by the variable number idx in the management number array. The enlargement processing can be optically realized in the case where the image is a still image and the lens 202 includes an optical zoom function.

The size after the reduction in step S513 and the size after the enlargement in step S516 can be determined based on the communication status. In this way, the communication data amount is controlled based on whether the communication status is good or bad.

In step S517, the system control unit 216 transmits an inquiry about an analysis of the image generated in steps S513, S514, and S516 to the image analysis server 103. The system control unit 216 transmits the inquiry to the image analysis server 103 together with information for uniquely identifying the captured image and the object management number.

In step S518, the system control unit 216 stores the analysis result returned from the image analysis server 103 in the inquiry result 404 of the record of the management number in the object management table that is stored in the location specified by the variable number idx in the management number array. Specifically, the system control unit 216 stores the analysis result from the image analysis server 103 in the inquiry result 404 in the object management table in association with the corresponding object. For example, in the case where the object recognized in step S501 is an image of an automatic car, an analysis result specifying the type of the automatic car (e.g., car type NI) is returned from the image analysis server 103. In the case where the object recognized in step S501 is an image of the face of a person, an analysis result specifying who the person is (e.g., person C) is returned from the image analysis server 103. The image analysis server 103 stores dictionary data for more detailed object classification/recognition compared to the information processing apparatus 101.

The system control unit 216 of the information processing apparatus 101 controls post-processing such as tagging the captured image, displaying a balloon near the object image, selecting the image capturing mode of the information processing apparatus 101, or performing selective transmission of the image capturing result based on the inquiry result 404.

In step S519, the system control unit 216 adds (increments) one to the variable number idx, and the processing returns to step S511.

While an inquiry about an analysis of each object is sequentially transmitted to the image analysis server 103 for the convenience of description, the inquiries can be successively transmitted in parallel.

In this case, since the inquiries are transmitted in parallel to the image analysis server 103, the inquiry result 404 includes information indicating “under inquiry”, and if a response is received from the image analysis server 103, the analysis result is set to the inquiry result 404 based on the object management number.

Since the inquiries are transmitted in parallel to the image analysis server 103, the next frame processing can be performed. In this case, the object that disappears from the captured image in the next frame can be under inquiry, but since there is no record corresponding to the management number of the response from the image analysis server 103, no analysis result is stored.

As described above, the information processing apparatus 101 transmits an object image obtained by cutting the captured image and not the entire captured image to the image analysis server 103, so that the data amount of communication between the information processing apparatus 101 and the image analysis server 103 can be reduced.

Since only one inquiry is transmitted to the image analysis server 103 for the same object that is present in consecutive frames of the captured image and the object image is transmitted only once, the data amount of communication between the information processing apparatus 101 and the image analysis server 103 can be reduced.

The record of the object that disappears from the captured image is erased from the object management table, and if a similar new object appears in a captured image next time, an inquiry is transmitted to the image analysis server 103. Thus, in the case where an object is similar but is likely a different object, the analysis is performed, so that it is possible to increase the accuracy of object recognition.

While the configuration in which the digital camera is employed as the information processing apparatus 101 has been described above, the present disclosure is also applicable to a control apparatus of a monitoring camera system in which an image captured by one or more monitoring cameras is processed and combined and displayed with an image analysis result of each object.

While an exemplary embodiment of the present disclosure has been described in detail above, the present disclosure is not limited to the specific exemplary embodiment, and various forms within the spirit of the disclosure are also encompassed within the scope of the disclosure. Parts of the above-described exemplary embodiment can be combined as needed.

In an exemplary embodiment of the present disclosure, an unanalyzed partial image from among partial images generated by cutting for each object is transmitted to an image analysis server, so that the frequency of communication for partial image transmission can be reduced to reduce the communication data amount and the accuracy of object recognition based on the partial image can be improved.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-232334, filed Dec. 4, 2017, which is hereby incorporated by reference herein in its entirety.

What is claimed is:

1. An information processing apparatus comprising:
a processor; and
a memory storing a program which, when executed by the processor, causes the information processing apparatus to:
input image data;
detect an object included in the image data;
acquire a region of the detected object in the image data;
store the acquired region for each object in an object management table;
erase, from the object management table, an object that is stored in the object management table and is not included in new input image data;
transmit, to an image analysis apparatus, an object image cut from the image data based on a region of the object that is stored in the object management table and with which no associated analysis result is stored;
receive a result of analysis of the object image from the image analysis apparatus; and
store the result of analysis of the object image in the object management table in association with a corresponding object.

2. The information processing apparatus according to claim 1, wherein the image data is captured image data acquired by an image capturing unit.

3. The information processing apparatus according to claim 1, wherein the object image is not transmitted to the image analysis apparatus if the object image is smaller than a minimum size.

4. The information processing apparatus according to claim 1, wherein the object image is reduced and the reduced object image is transmitted to the image analysis apparatus if the object image is larger than a maximum size.

5. The information processing apparatus according to claim 1, wherein the object image is enlarged or reduced to a predetermined size range and the enlarged or reduced object image is transmitted to the image analysis apparatus.

6. An information processing method comprising:
inputting image data;
detecting an object included in the image data;
acquiring a region of the detected object in the image data;
storing the acquired region for each object in an object management table;
erasing, from the object management table, an object that is stored in the object management table and is not included in new input image data;
transmitting, to an image analysis apparatus, an object image cut from the image data based on a region of the object that is stored in the object management table and with which no associated analysis result is stored;
receiving a result of analysis of the object image from the image analysis apparatus; and
storing the result of analysis of the object image in the object management table in association with a corresponding object.

7. A non-transitory computer-readable storage medium that stores a program for causing a computer to execute a method, the method comprising:
inputting image data;
detecting an object included in the image data;
acquiring a region of the detected object in the image data;
storing the acquired region for each object in an object management table;
erasing, from the object management table, an object that is stored in the object management table and is not included in new input image data;
transmitting, to an image analysis apparatus, an object image cut from the image data based on a region of the object that is stored in the object management table and with which no associated analysis result is stored;
receiving a result of analysis of the object image from the image analysis apparatus; and
storing the result of analysis of the object image in the object management table in association with a corresponding object.
